(19) United States
(12) Patent Application Publication
(10) Pub. No.: US 2012/0059855 A1
(43) Pub. Date: Mar. 8, 2012

(54) METHOD AND COMPUTER PROGRAM PRODUCT FOR ENABLING ORGANIZATION OF MEDIA OBJECTS

(75) Inventors: Prasenjit Dey, Kamataka (IN); Sriganesh Madhvanath, Kamataka (IN); Ramadevi Vennelakanti, Kamataka (IN)

(73) Assignee: HEWLETT-PACKARD DEVELOPMENT COMPANY, L.P., Houston, TX (US)

(21) Appl. No.: 13/260,035

(22) PCT Filed: May 26, 2009
(86) PCT No.: PCT/IN2009/000304

§ 371 Date: Sep. 23, 2011

(51) Int. Cl. G06F 17/30

(52) U.S. Cl. 707/792; 707/E17.055

(57) ABSTRACT

A method for enabling organization of a plurality of media objects is disclosed. The method comprises playing a digital media object to a user; capturing the interaction of the user with the played digital media object; and tagging the played digital media object based on said interaction. A software program product implementing this method, a system comprising the software program product and a digital media object tagged in accordance with this method are also disclosed.

### BACKGROUND OF THE INVENTION

Nowadays, most media content such as photographs, videos, music files and so on, is captured and stored on digital data storage devices, e.g. computers, in a digital form. Consequently, such digital data storage devices can contain substantial numbers of digital media objects, e.g. digital files comprising such media. Due to the large number of digital media objects stored on such data storage devices, there is a need to tag such objects to allow for the organization of the object in data structures, e.g. databases, on the digital data storage device.

Such tags typically comprise some form of metadata, for instance a timestamp or a date stamp, GPS coordinates of a location where the digital media object was generated, the identity of a person in the media object, which may have been extracted from the media object using face recognition techniques, and so on.

However, such metadata is typically generated together with the media object and is therefore incapable of tracking the use of the media object over time. A user, e.g. a viewer of a listener, of such media objects must therefore rely on manual organization of the media objects as a function of such use, which is a cumbersome and error-prone task.

### BRIEF DESCRIPTION OF THE EMBODIMENTS

Embodiments of the invention are described in more detail and by way of non-limiting examples with reference to the accompanying drawings, wherein

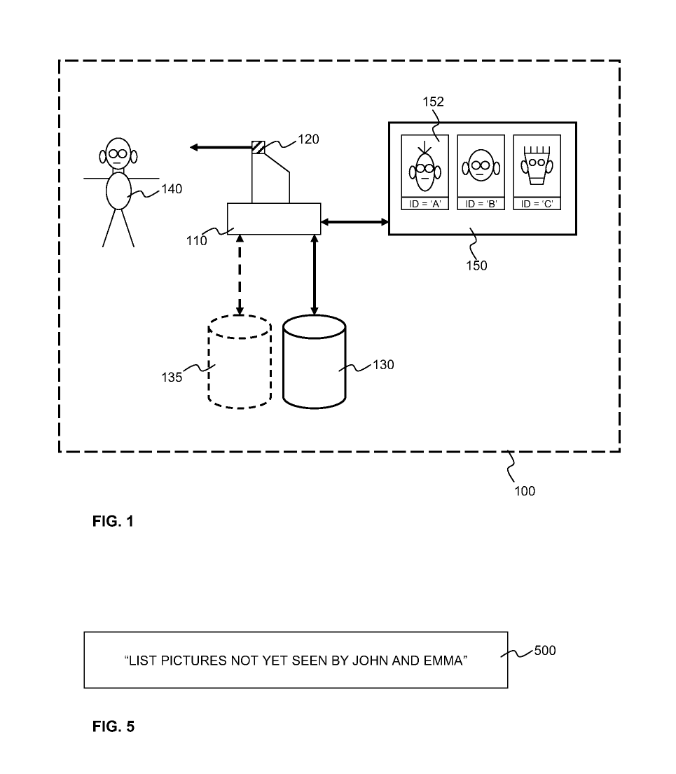

FIG. 1 schematically depicts a system in accordance with an embodiment of the present invention;

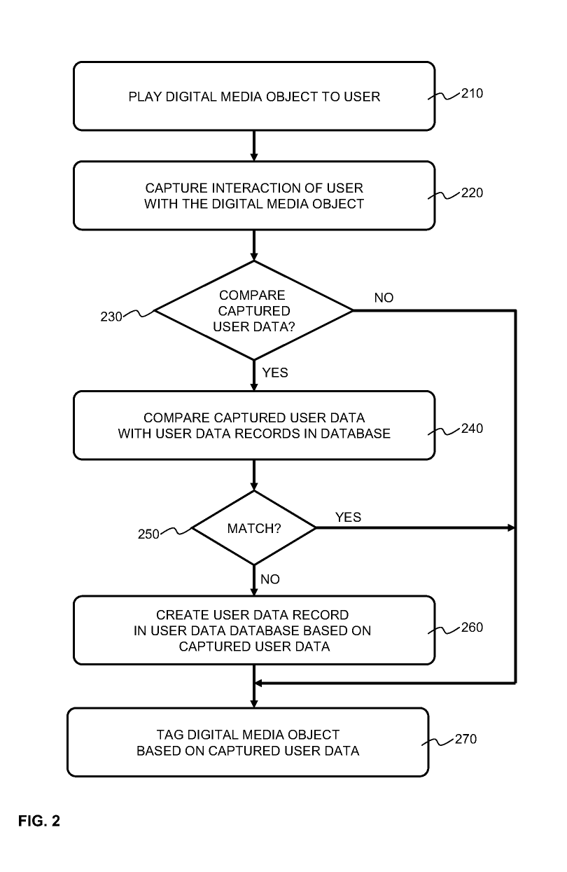

FIG. 2 depicts a flow graph of various methods in accordance with several embodiments of the present invention;

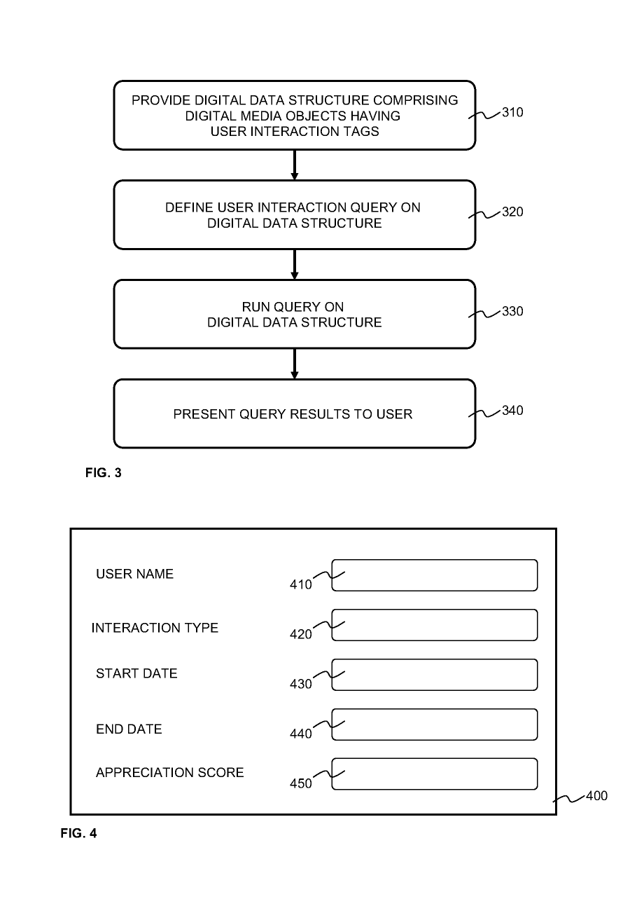

FIG. 3 depicts a flow graph of a method in accordance with a further embodiment of the present invention;

FIG. 4 schematically depicts an aspect of a software program product in accordance with an embodiment of the present invention; and

FIG. 5 schematically depicts an aspect of a software program product in accordance with another embodiment of the present invention.

### DETAILED DESCRIPTION OF THE DRAWINGS

It should be understood that the Figures are merely schematic and are not drawn to scale. It should also be understood that the same reference numerals are used throughout the Figures to indicate the same or similar parts.

FIG. 1 shows a system 100 in accordance with an embodiment of the present invention. The system 100 comprises a digital data processing device 110, such as a personal computer, a multi-functional set-top box, a digital camera, a multimedia player and so on. In general, the digital data processing device 110 may be any device capable of playing digital media objects to a user. In the context of the present application, it should be understood that “playing” includes any form of reproducing a media object to a user, such as displaying video content or still digital photographs, as well as play-back of a digital audio files such as MP3 music files.

The digital data processing device 110 comprises means 120 for capturing the interaction of a user 140 with a digital media object played to the user on the digital data processing device 110. In the context of the present application, user interaction data is intended to comprise any data that captures some form of interaction between the media object being played and the user watching or listening to the media object. This may for instance be a registration of the appreciation of the media object by the user as demonstrated by user gestures, (rhythmical) user movement, user facial expression, duration of the play time of the media object by a user, audible user response to the media object, e.g. spoken word, number of times the media object has been played and so on.

Also, the user interaction data may comprise information about the number of users playing the media object at the same time, the age and gender of the user and so on. Other examples of types of data that capture the history of users accessing a media object will be apparent to the skilled person. Different types of user interaction data may be combined into a single user identification data tag or may be stored in separate user interaction data tags, such as the identity of a user, the date and time the user accessed the media object and the captured appreciation of the media object by the user.

In an embodiment, a tag is a portion of metadata that can be accessed for search purposes. It is not necessary that all additional information attached to the media object is added to the media object in tag form, i.e. is searchable. Some information may be added as data, e.g. untranscribed speech, only, which can be retrieved in any suitable manner.

In an embodiment, the user interaction data comprises the identity of the user 140, such as a user name for instance. The identification of the user may be achieved in any suitable manner. In an embodiment, the means 120 comprise means for capturing user identification information, such as biometric data of the user 140. This may be any suitable biometric data such as for instance fingerprint data or other suitable data, in which case the means 120 for instance may comprise a fingerprint scanner or another suitable biometric sensor device.

In a preferred embodiment, the user identification information comprises face recognition data, in which case the means 120 may comprise a digital camera for capturing still pictures or streaming video data. In an embodiment, the digital camera may be arranged to capture a sequence of digital images of the user area, wherein user interaction data is only added as a tag when the user appears in at least a defined percentage of all the captured images. This avoids adding user interaction data to digital media object for people not interacting with the media but who were temporarily appearing in the user area for different reasons.

The digital data processing device 110 may be configured to open a digital media object such as a digital photograph, a digital video, a digital music file and so on from a digital media object database 135 in response to a request from the user 140. In an embodiment, the digital media object database 135 is comprised within the digital data processing device 110, for instance stored on a storage media such as a hard disk or another suitable storage media of the digital data processing device 110. In another embodiment, the digital media object database 135 is an Internet-accessible database such as You Tube or the Apple ITunes store. Other examples of such an Internet-accessible digital media object database will be immediately apparent to the skilled person.

The digital data processing device 110 further has access to a further digital media object database 130 in which digital media objects that are tagged by the digital data processing device 110 in accordance with an embodiment of the present invention can be stored. In an embodiment, the digital data processing device 110 can retrieve the digital media objects from the further digital media object database 130 such that the digital media object database of 135 may be omitted. It will be appreciated that the further digital media object database 130 may be comprised in the digital data processing device 110 or may be an external database such as an Internet-accessible database.

In an embodiment, the digital data processing device 110 further has access to a user recognition database 150, which comprises user records 152 with each user record 152 typically comprising user interaction data such as biometric data by which the user can be identified, or user characteristics such as a face or fingerprint image from which user identification data such as biometric data can be extracted. The user recognition database 150 may be any suitable database, such as a proprietary database comprised in the digital data processing device 110 or an Internet-accessible user recognition database, such as Facebook. A suitable Internet-accessible user recognition database comprises the same type of user identification data, e.g. biometric data, as captured by the means 120 such that a comparison between the captured data and the data stored in the database 150 is possible.

In an embodiment, the user recognition database 150 forms part of a software program product for tagging digital media objects. The user recognition database 150 maybe constructed in any suitable way, for instance by importing a list of potential users of the digital media objects, e.g. friends and family member details from another database such as an e-mail address list, and adding biometric data for each potential user, e.g. by extracting face recognition data from pictures of these potential users. It is emphasized that many other suitable techniques of constructing such a database are readily available to the skilled person and that any of those techniques may be chosen. Also, the user recognition database 150 may take any suitable form. These techniques are not further discussed for reasons of brevity only.

An aspect of the system 100 in operation in accordance with an embodiment of a method of the present invention will be explained in more detail with the aid of FIG. 2. In a first step 210, a digital media object is played to the user 140. As previously explained, such a digital media object may be an audio file, a video file, a still image and so on. Any suitable digital media object format may be used. In the context of the present application, a suitable digital media object format is a format which allows the addition of metadata to the digital object. Non-limiting examples of suitable formats include JPEG, MPEG, MP3, GIF, RAW, WAV and so on. In step 220, the data processing device 110 through means 120 is configured to capture the interaction of the user with the digital media object.

In an embodiment, the interaction capturing comprises the recognition of the user 140 by means of user identification data biometric data such as face recognition data, thereby allowing the digital media object to be tagged with the identity of the user 140 such that analysis of the tag of the digital media object at a later date will provide useful information of users that that have previously accessed the digital media object. It is pointed out that the techniques for identification of a user on the basis of user identification data such as biometric data such by means of face recognition are well-known in the art and will therefore not be discussed in further detail for the sake of brevity only.

The captured interaction data may comprise identification data, e.g. biometric data, which may be stored directly as user interaction metadata in the digital media object viewed by the user 140, as shown in step 270. However, in a preferred embodiment, the captured interaction data comprising identification data, in step 240, is compared to identification data stored in a user interaction database such as the database of 150 shown in FIG. 1, from which the identity of the user is established, which identity is subsequently comprised in the user interaction data tag added to the media object. Both embodiments are captured in the method shown in FIG. 2 by means of decision step 230. It is pointed out that step 230 is only included for the sake of demonstrating that multiple embodiments of the method shown in FIG. 2 are feasible and is not intended to be a discrete step in any embodiment of the method shown in FIG. 2.

In an embodiment, each record 152 in the user recognition database 150 is configured to comprise a photograph of the user identified in that record wherein in step 240 biometric data is extracted from both the photograph captured by the means, i.e. camera, 120 and the photographs stored in the records 152, after which the respectively extracted biometric data is compared to identify the user 140.

Following on from step 240, an evaluation step 250 may be included to verify if the user identification data captured in step 220 has been successfully matched to user identification data stored in the database 150. If this is the case, the method may proceed to step 270 in which the identity of the user extracted from the database 150 based on the match between the captured user interaction data and the stored user interaction data is added as user interaction metadata to the digital media object.

In an embodiment, if no successful match between the captured user interaction data and the stored user interaction data could be found, the tagging step 270 may be omitted. Alternatively, an additional step 260 may be added to the method in which a database user identification record 152 is created for the new user. This may be done in any suitable manner, for instance by prompting the user 140 to feed user details into the system 100 using any suitable input medium, such as a keyboard, keypad, mouse and so on. Upon creation of the user identification record 152, the method may proceed with tagging the played digital media object with the identified user in step 270.

In an embodiment, the tagging of the digital media object based on the captured user interaction data may be postponed until the activity of the digital data processing device 110 falls below a defined level such as a defined percentage of CPU utilization. This has the advantage that potentially processing-intensive operations can be performed at suitable times in the operation background of the digital data processing device 110. In an embodiment, the user 140 may play multiple digital media objects before the played objects are tagged. In this embodiment, the tagging of the digital media objects is performed as a batch job, which for instance may be performed as soon as the user has terminated the application for playing the digital media objects or may be performed in the background as previously explained.

As previously explained, the tag added to the played, e.g. viewed or listened to, digital media object is based on the interaction of the user 140 with the digital media object, and preferably comprises identification information of the user 140 such that the digital media object that is tagged in accordance with an embodiment of the present invention comprises an user access history, wherein each time a user plays the digital media object its tag is updated by adding the user interaction information to the tag.

In a further embodiment, the digital media object tag may also comprise user interaction data indicative of the user appreciation of the digital media object. For instance, the play duration of the digital media object or the access frequency of the digital media object may be recorded in the tag. In an embodiment, a user appreciation score is derived from this data. For example, in case of a music file being played for a relatively short period of time, a low appreciation score may be assigned to the file whereas in case of the same file being played for a relatively long period of time (to or near to completion), a relatively high appreciation score may be assigned to the file.

Alternative embodiments of such user appreciation data will be apparent to the skilled person. For instance, user gestures, speech, movement or facial expressions may be interpreted in terms of user appreciation. This additional information may be included in the tag in any suitable manner or format. This may be combined with information concerning specific parts of the media object being appreciated by the user interaction with the media object. For instance, a user may point at a part of the screen to show appreciation for a specific part of the media object or demonstrate appreciative facial expressions during parts of a played streaming media object only. The user interaction data may capture this selective appreciation, e.g. “user X pointed at top left quadrant of image” or “user Y danced to the first 30 seconds of this song” and so on.

In an embodiment, a further tag comprising conventional tag information may be added to the played digital media object. The further tag may be a separate tag or may be integrated into the tag based on the user interaction with the digital media object. Any suitable conventional tag information may be included in the further tag. Non-limiting examples of such conventional tag information include a date stamp, a timestamp, GPS location coordinates, the identity of objects in the digital media object such as the names of people captured in a digital video or photograph and so on.

The tags based on user interaction data optionally combined with one or more further tags such as content tags, location tags, date and time tags and so on opens up advantageous possibilities of organizing and/or retrieving tagged digital media objects in or from a database such as database 135 in FIG. 1. For instance, the tagged digital media objects may be organized in accordance with the user interaction captured in the tags. For example, such a database may comprise different categories such as “digital media objects played by me”, “digital media objects not yet played by me”, and so on. Many different ways of organizing digital media objects tag in accordance with one or more embodiments of the present invention will be apparent to the skilled person and will not be explained in full detail for reasons of brevity only.

An embodiment of a method of retrieving such tagged digital media objects is shown in FIG. 3. In step 310, a digital data structure such as a database 135, a file repository, or any other suitable data structure comprising digital media objects of which at least some are tagged in accordance with one or more embodiments of the present invention is provided. It is reiterated that the provision of such a data structure falls within the routine skill of the skilled person and is not explained in further detail for that reason.

In step 320, a further user which may be the user 140 or another user defines a query on the digital data structure, which at least part of the query relating to the tags of the digital media objects that are based on the previously discussed interaction of a user 140 with the played digital media object. Non-limiting examples of such queries include: “photographs of John I saw yesterday”, “recent photographs of London Suzie found interesting”, photographs not seen by me and Sally yet”, “videos frequently viewed by me over the past year”, “photos that Mom and Dad watched together last week (in which multiple user identities have been added as user interaction data), “the comment John made about this photo when John and Debby watched this photo last week”, “photos that only I have seen” and so on. Many other examples will be apparent to the skilled person.

The above examples all include user identity in the user interaction information. However, it is reiterated that embodiments in which the user identity is not included in the user interaction data are equally feasible. For instance, user interaction tags like “watched by 3 people at date A” allow queries like “what are the most viewed photos in my collection”, “photos I show to large groups of people” and so on. Obviously, user identity may also be used to extract this information since a tag comprising three different user identities can be interpreted as a media object watched by three different people.

In a further embodiment, in case the media object contains individually defined features within the object, the user interaction data may comprise interaction of the user with the individually defined feature, for instance by the detection of the user pointing at the feature or touching the screen where the feature is displayed. Such detection is known per se and will not be further explained for reasons of brevity. This allows for the tagging of specific parts of the media object, i.e. the tagging of the individually defined features. This opens up the possibility for more complex queries such as “Did John say anything about the lighthouse on the beach in this photo?”, “Did Wendy smile at the clown in this picture?” and so on.

Table I shows a non-limiting example of how such queries may be interpreted by a search algorithm operating on the digital data structure comprising the tagged digital media objects.

TABLE I

| Query | Interpreted As |
|---|---|
| photographs of John I saw yesterday | Date = yesterday, viewed_by = |
| | me, subjects = John |
| recent photographs of London Suzie | Date_taken = within last month, |
| found interesting | GPS_location = London, |
| | viewed_by = Suzie, Activity |
| | >60% |
| photographs not seen by me and Sally | Viewed_by ≠ ’Me or Sally’ |
| yet | |
| videos frequently viewed by me over | Viewed_by = me, |
| the past year | Play_frequency > threshold value |

The extraction of search parameters from such queries may be achieved using any suitable parsing technique. Such techniques are known per se and will not be discussed in further detail for reasons of brevity only. As will be apparent from the non-limiting examples in the above Table, the parameter viewed_by relates to tag information based on the aforementioned user interaction, the parameters Play_frequency and Activity relate to the appreciation of the digital media object by a user playing that object, whereas the other parameters relate to conventional tag information. It will be immediately apparent that the inclusion of a tag in a digital media object based on the interaction of a user with that object the possibilities of selecting or finding certain digital media objects are greatly enhanced. For instance, as shown in the above examples, it becomes possible to select digital media objects not yet played by a certain user or to select digital media objects that have been appreciated by users playing the objects. In an embodiment, a snapshot of the user interaction, e.g. user appreciation, is added as a user interaction tag, such as a snapshot of John laughing at the media object. This allows future users of the media object to classify the media object using their own perception of a prior user's response to the media object, e.g. by the analysis of the facial expression of John in the above example. Furthermore, such snapshots can help visualize the history of the media object, which may be a powerful tool to relive memories of a user, such as a snapshot potentially combined with an audible response of the interaction of a deceased friend or relative with a media object.

For the sake of completeness, is pointed out that the parameters shown in the above table are non-limiting examples of suitable parameters and that other suitable parameters based on alternative embodiments of user interaction, user appreciation and/or conventional tags are equally feasible.

Upon the definition of the query in step 320, the method proceeds to step 330 in which the query is run on the digital data structure and completed by step 340 in which the query results are presented to the user defining the query.

It should be appreciated that the query defined in step 320 may be defined in any suitable form. For instance, as shown in FIG. 4, the user may be presented with a menu 400 in which the various parameters available to the search algorithm that runs the query on the data structure comprising the tagged digital media objects may be specified. By way of non-limiting example, FIG. 4 shows a parameter “user name” relating to the identity of a user previously interacting with one or more of the digital media objects stored in the digital data structure, a parameter “interaction type” relating to the type of interaction between the user and the digital media object, parameters “start date” and “end date” allowing the definition of a query over a time period identified by these dates and a parameter “appreciation score” in which the appreciation of the user previously interacting with the digital media object may be specified. The user defining the query may specify these parameters in respective boxes 410-450, which may allow the user to input the desired parameter values in any suitable way such as by means of typing or by means of drop down menus providing the user with available parameter values.

A further non-limiting example of a suitable way of defining such a query is shown in FIG. 5, in which the user is presented with a query box 500 in which a query may be specified, such as the queries shown in Table I. Many other suitable ways of defining such a query will be apparent to the skilled person, such as the specification of the query by means of speech, in which case the digital data processing device of 110 may comprise voice recognition software for interpreting the spoken query.

In an embodiment, a software program product is provided that comprises program code for executing one or more embodiments of the method of the present invention. Since such program code may be generated in many different suitable ways, which are all readily available to the skilled person, the program code is not discussed in further detail for reasons of brevity only. The software program product may be made available on any suitable data carrier that can be read by a digital data processing device 110. Non-limiting examples of a suitable data carrier include CD-ROM, DVD, memory stick, an Internet-accessible database and so on.

In another embodiment, a system, or apparatus, comprising the aforementioned software program product is provided. Non-limiting examples of suitable systems include a personal computer, a digital camera, a mobile communication device including a digital camera and so on.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A method for enabling organization of a plurality of media objects, comprising:
playing a digital media object to a user;
capturing the interaction of the user with the played digital media object; and
tagging the played digital media object based on said interaction.

2. The method of claim 1, further comprising further tagging the played digital media object with a further tag.

3. The method of claim 1, further comprising providing a database comprising a plurality of user identity records, each record comprising user identification data of said user, and wherein:
said capturing step comprises capturing user identification data of the user and comparing the captured user identification data with the user identification data of said user identity records; and
said tagging step comprises tagging the played digital media object with the user identity extracted from said database upon matching the captured user identification data with the user identification data of one of said user identity records.

4. The method of claim 1, wherein said interaction further comprises the response of the user to the played digital media object.

5. The method of claim 1, wherein said tagging further comprises including the duration of the interaction of the user with the played digital media object.

6. The method of claim 1, wherein said playing and capturing steps are executed for respective digital media objects prior to executing the respective tagging steps for said respective played digital media objects.

7. The method of claim 6, wherein said respective tagging steps are postponed until the computer activity has dropped below a defined activity threshold.

8. The method of claim 1, further comprising organizing the tagged digital media objects into an electronic data structure.

9. The method of claim 8, further comprising:
defining a user interaction query;
accessing the electronic data structure;
comparing the tags of the digital media objects with the user interaction query; and
listing the digital media objects matching the user interaction query.

10. The method of claim 9, further comprising:
playing at least one of said listed digital media objects to a further user;
capturing the interaction of the further user with the at least one digital media object; and
updating the tag of the at least one played digital media object based on said interaction.

11. A software program product for, when executed on a processor, implementing the steps of the method of claim 1.

12. A system comprising the computer program product of claim 11 and a processor for executing the computer program product.

13. The system of claim 12, further comprising means for capturing the interaction between the user and the played media object in the form of user identification data.

14. A digital media object comprising a tag based on the interaction of a user with said media object when played to said user.

15. A digital data structure comprising a plurality of digital media objects including at least one digital media object as claimed in claim 14.
